(19) United States
(12) Patent Application Publication
(10) Pub. No.: US 2009/0217058 A1
(43) Pub. Date: Aug. 27, 2009

(54) SECURE DATA TRANSFER AFTER AUTHENTICATION BETWEEN MEMORY AND A REQUESTER

(75) Inventors: Willy Obereiner, San Jose, CA (US); Hendrik Graulus, Los Gatos, CA (US)

Correspondence Address: TUROCY & WATSON, LLP, 127 Public Square, 57th Floor, Key Tower, CLEVELAND, OH, 44114, US

(73) Assignee: SPANSION LLC, Sunnyvale, CA (US)

(21) Appl. No.: 12/038,059

(22) Filed: Feb. 27, 2008

(51) Int. Cl. G06F 12/14

(52) U.S. Cl. 713/193

(57) ABSTRACT

Systems and/or methods are presented that can facilitate controlling access to secure memory blocks within a memory module. The subject innovation can employ key components that can contain two or more storage locations for authentication information that can facilitate controlling access to secure memory block components. Secure memory block counter components can be employed to indicate which storage location within the key component contains current authentication information associated with the respective secure memory block components. The disclosed subject matter allows for multiple secure memory block components to have separate authentication information to provide more than one user or entity to store data in their own secure memory block component. Multiple storage locations associated with the key components to substantially alleviated or eliminate the loss of secure areas of a memory module if power is lost during the updating of the authentication information associated with the secure areas.

### TECHNICAL FIELD

The subject innovation relates generally to memory systems and in particular to systems and methods for securing information associated with memory devices.

### BACKGROUND

A wide variety of memory devices can be used to maintain and store data and instructions for various computers and similar systems. In particular, flash memory is a type of electronic memory media that can be rewritten and that can retain content without consumption of power. Flash memory has become popular, at least in part, because it combines the advantages of the high density and low cost of EPROM with the electrical erasability of EEPROM. Flash memory is nonvolatile; it can be rewritten and can hold its content without power. Flash memory can be used in many portable electronic products, such as cellular phones, portable computers, voice recorders, thumbnail drives and the like, as well as in many larger electronic systems, such as cars, planes, industrial control systems, etc. The fact that flash memory can be rewritten, as well as its retention of data without a power source, small size, and light weight, have all combined to make flash memory devices useful and popular means for transporting and maintaining data.

Conventionally, data can be stored in memory that can be associated with electronic devices, such as a cellular phone, digital camera, handheld computer, personal digital assistant (PDA), etc. The memory typically has only one region of the memory that is protected from unauthorized access and is limited in capability and flexibility. Typically, a user can have sensitive personal information stored in the memory on the electronic device, and the user can desire to maintain the privacy of such information wherein the user is required to authenticate to gain access to the secure area of memory. Sometimes a user may wish to change the authentication information that can be associated with the secure area of memory (e.g., to change a password). However, there is a critical time period when the authentication information is being updated when the memory can be unable to distinguish between when to use the old authentication information and the new authentication information. For example, if the memory loses power when the authentication information is being updated, the memory may utilize the wrong authentication information when power is restored (e.g., the new authentication information may not have been written to memory prior to the memory module losing power).

### SUMMARY

The following presents a simplified summary of the innovation in order to provide a basic understanding of some aspects described herein. This summary is not an extensive overview of the disclosed subject matter. It is intended to neither identify key or critical elements of the disclosed subject matter nor delineate the scope of the subject innovation. Its sole purpose is to present some concepts of the disclosed subject matter in a simplified form as a prelude to the more detailed description that is presented later.

Conventionally, a memory device can be associated with one secure memory area wherein an entity can be required to provide proper authentication information to gain access to the secure memory area. Further, a memory controller that can be associated with the memory typically manages the authentication requirements to access the secure memory area. However, it can be desirable to provide multiple secure memory areas associated with a memory, wherein information (e.g., sensitive information) such as, for example, service provider data, original equipment manufacture (OEM) data, and/or user data can be stored in separate secure memory areas, wherein only the authorized entity (e.g., service provider, OEM, user) can access the information contained within the separate secure memory areas associated with the respective entities. It can be further desirable to have the authentication tasks performed within the memory (e.g., on the same die as the memory) as opposed to a separate component (e.g., a memory controller) managing the authentication requirements of a memory.

The disclosed subject matter relates to systems and/or methods that facilitate securing data associated with a memory device. In accordance with one aspect of the disclosed subject matter, a memory module can include a memory array(s) (e.g., nonvolatile memory array) that can contain a plurality of memory cells wherein each memory cell can stored one or more bits of data. In one aspect, the memory array(s) can include, or can be partitioned into, one or more memory areas that can respectively contain and/or be associated with a subset of the memory cells. The memory module can be employed in an electronic device, such as, for example, a cellular phone, digital camera, handheld computer, personal digital assistant (PDA), global positioning system device (GPS), etc., and different users of the electronic device can gain access to the different memory areas in the memory module, where each memory area can require authentication respectively associated therewith before access can be granted.

Conventionally, a memory controller, which can be associated with a host processor, can manage access to memory locations in a memory device, such as a memory location (or memory locations) that can require authentication information before access can be granted to that memory location. In addition, memory controllers typically only provide one region within memory that can be protected against unauthorized access. The subject innovation employs a secure memory component that can be comprised of several secure memory block components that can provide virtually any number of secure areas that can support virtually any number of users.

In accordance with one aspect, a memory module can include a secure memory component that can be employed to facilitate controlling access to one or more secure memory block components. In one aspect, the memory module can include an authentication component that can facilitate controlling the setting of a authentication information (e.g., passwords, keys) of one or more of a respective users; enabling read, write, and or erase functions based in part on received authentication information that can be compared to stored authentication information contained in or associated with the authentication component (e.g., within a keys component).

For example, several entities (e.g., an OEM, service provider, and/or one or more end-users) can have and maintain one or more secure memory block components that can be associated with a memory module. Each of the entities can, for example, also have authentication information that can be stored in the memory module as well. The several entities can access, erase, and update the information stored in their respective secure memory block component(s) by providing the correct authentication information to an authentication component to gain access to the respective secure memory block component(s).

The following description and the annexed drawings set forth in detail certain illustrative aspects of the disclosed subject matter. These aspects are indicative, however, of but a few of the various ways in which the principles of the innovation may be employed and the disclosed subject matter is intended to include all such aspects and their equivalents. Other advantages and distinctive features of the disclosed subject matter will become apparent from the following detailed description of the innovation when considered in conjunction with the drawings.

### BRIEF DESCRIPTION OF THE DRAWINGS

FIG. 1 illustrates a block diagram of a system that can facilitate control of access to a secure memory component in accordance with an aspect of the subject matter disclosed herein.

FIG. 2 depicts an example of a block diagram of a system that can facilitate control of access to memory components associated with a memory module in accordance with an aspect of the disclosed subject matter.

FIG. 3 is a block diagram depicting a memory module that can facilitate data storage in accordance with an aspect of the subject matter disclosed herein.

FIG. 4 depicts a block diagram of an example of a system that can store data in accordance with an embodiment of the disclosed subject matter.

FIG. 5 depicts a block diagram of an example system that can employ a secure memory component associated with a memory module in accordance with an aspect of the disclosed subject matter.

FIG. 6 depicts a methodology that can facilitate controlling access to memory blocks associated with a memory module in accordance with an aspect of the disclosed subject matter.

FIG. 7 illustrates a methodology that can facilitate updating authentication information in accordance with an aspect of the disclosed subject matter.

FIG. 8 illustrated a methodology that can facilitate controlling access to a secure memory block in accordance with an aspect of the disclosed subject matter.

FIG. 9 illustrates an example of an electronic device that can be associated with a memory in accordance with an aspect of the disclosed subject matter.

### DETAILED DESCRIPTION

The disclosed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the disclosed subject matter may be practiced without these specific details. In other instances, well-known structures and devices are shown in block diagram form in order to facilitate describing the subject innovation.

Conventionally, a memory controller can control access to a memory, or a portion thereof, that can be associated with the memory controller. However, the security that can be afforded by a memory controller can be bypassed by disconnecting the memory from the memory controller, wherein one could connect another memory controller to the memory to gain access to areas of memory that were previously secured by programs and/or algorithms associated with the memory controller that was removed. In addition, conventionally, only one set of authentication information associated with controlling access to a particular memory area or block of a memory is stored within a memory controller. However, if, for example, during the process of updating the authentication information (e.g., if a user desires to change the authentication information associated with a particular area of memory) the memory controller experiences a loss of power, the new authentication information can be lost or corrupted as well as the old authentication information can be lost or corrupted. In such an example, it is possible that the area of memory that was secured using the authentication information (e.g., that become corrupted because of the memory controller losing power during the authentication information update) could be permanently lost if there is not a way to circumvent the existing security that can be associated with the authentication information. It is to be appreciated that authentication information can become lost and/or corrupted via other means (e.g., power surges, process interruptions etc.) as well.

Systems and/or methods are presented that can facilitate controlling access to secure memory blocks within a memory module. The subject innovation can employ key components that can respectively contain storage locations (e.g., one, two, or more storage locations) for authentication information that can be used to control access to associated secure memory block components. Secure memory block counter components can be employed to indicate which storage location within the respective key components contain the latest (e.g., most current) authentication information associated with respective secure memory block components. Further, different secure memory block components can have separate authentication information respectively associated with them to provide more than one user or entity a secure memory area (e.g., a secure memory block component) located in the memory module that can, for example, provide rights to the respective user(s) or entity(ies) to read, write, and/or erase the secure memory area. Further, the authentication can be the same or different with respect to each type of operation, as, for example, there can be a first authentication that can grant access to perform a read, and another authentication to grant access to perform a write, within a secure memory block component. As a result, multiple users and/or entities can be provided secure memory areas in the memory module. Further, the storage locations associated with the key components can substantially alleviate or eliminate the loss of the secure areas of a memory module if power is lost during the updating of the authentication information associated with the secure memory block components.

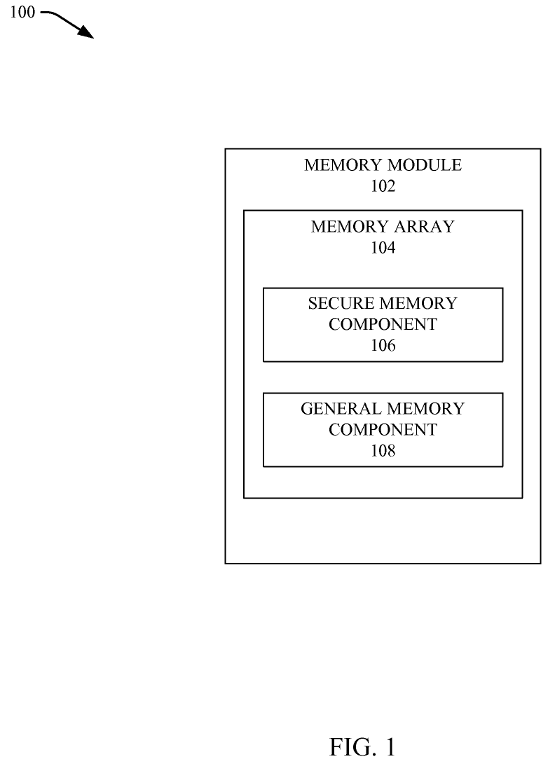

Turning to the figures, FIG. 1 illustrates a system 100 that can facilitate storing data in secure memory components (e.g., secure memory areas) in accordance with an aspect of the disclosed subject matter. System 100 can include a memory module 102 that can comprise, in part, a non-volatile memory (e.g., flash memory) and/or volatile memory (e.g., random access memory (RAM)). The memory module 102 can receive information, including data, commands, and/or other information, which the memory module 102 can process (e.g., store data, execute commands, etc.). The memory module 102 can include a memory array(s) 104 that can receive and store the data. The memory array 104 can include a plurality of memory cells (not shown) wherein each memory cell can store one or more bits of data. Data stored in a memory cell(s) in the memory array 104 can be read and such data can be provided as an output or can be erased from the memory cell(s). In one aspect, the data in a memory cell can also be written (e.g., programmed) to another value, depending on the memory technology.

In accordance with an aspect of the disclosed subject matter, the memory array 104 can include a secure memory component 106. The secure memory component 106 can, for example, comprise a non-volatile memory (e.g., flash) and/or a volatile memory (e.g., random access memory (RAM)) and can be comprised of a subset of memory cells (not shown), wherein data can be stored. The secure memory component 106 can contain data that can be secured whereby the data contained therein can be accessible only by an authorized user(s) or authorized entity(ies) (e.g., service providers and components, original equipment manufactures (OEM), user). The secure memory component 106 can be comprised of one or more secure areas that can be contained within the memory array 104. The secure memory component 106 and the internal components associated with the secure memory component 106 are discussed herein in further detail with regard to system 300.

The memory module 102 can also include a general memory component 108 that can also comprise a non-volatile memory (e.g., flash) and/or a volatile memory (e.g., random access memory (RAM)), for example. The general memory component 108 can comprise a subset of memory cells (not shown) in which data can be stored wherein the data can be accessed without the need for authentication. For example, all end users and/or entities can access this area of memory associated with the memory array 104 without having to provide authentication information (e.g., without requiring a password or pass phrase).

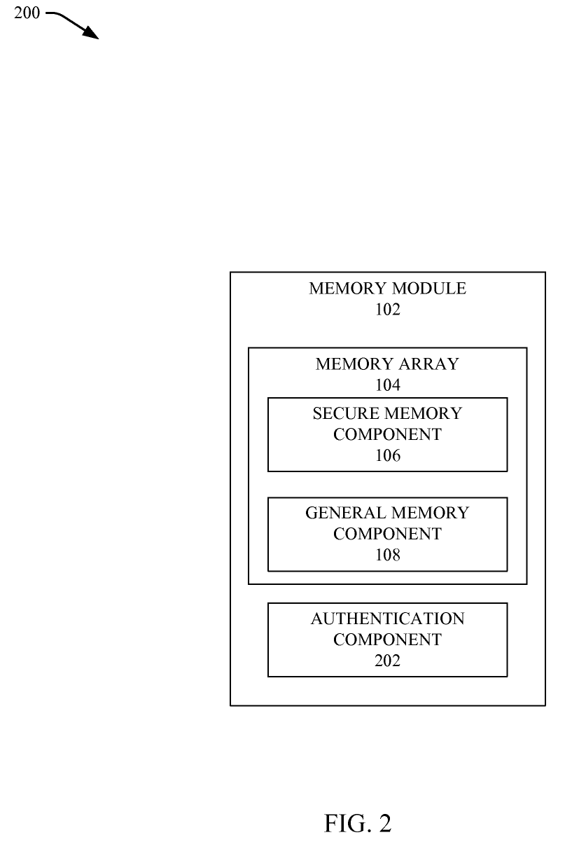

Turning to FIG. 2, depicted is a block diagram of a system 200 that can facilitate control of access to memory components associated with a memory module in accordance with an aspect of the disclosed subject matter. System 200 can comprise a memory module 102 that can be associated with a memory array(s) 104, wherein the memory array 104 can contain a secure memory component 106 and a general memory component 108. The secure memory component 106 can contain information wherein a user or entity can be required to provide proper authentication information (e.g., a password, personal identification number (PIN)) before access can be granted to the information contained therein. The memory module 102, memory array 104, secure memory component 106, and general memory component 108 can be the same as or similar to, and can include such functionality, as more fully described herein, for example, with regard to system 100.

In accordance one embodiment of disclosed subject matter, the memory module 102 can also include an authentication component 202. The authentication component 202 can facilitate controlling access to the secure memory component 106 wherein only the authorized user(s) or entity(ies) can gain access to the data/information contained in the secure memory component 106. The authentication component 202 can solicit authentication data (e.g., authentication credentials) from the user or entity, and upon receiving the proper authentication data from the user or entity can facilitate controlling the access to the secure memory component 106. For example, the authentication component 202 can compare the authentication information received from the user or entity to authentication information that can be stored within the authentication component 202 and/or can be stored in a memory array (e.g., a highly secure memory array (not shown)) within memory module 102, wherein the authentication component 202 can have exclusive access to the authentication information contained therein to facilitate control of access to a secure memory component 106, for example, and the authentication component 202 can grant access to the secure memory component 106 only if the received authentication information and the stored authentication information match. The authentication data can be in the form of a password, a pass phrase, a PIN (Personal Identification Number), and the like, for example.

Additionally and/or alternatively, public key infrastructure (PKI) data can also be employed by authentication component 202, for example. PKI arrangements can provide for trusted third parties to affirm entity identity through the use of public keys, wherein providing a way to control access to a secure area(s) (e.g., secure memory component 106) of the memory module 102, for example. Such arrangements can enable entities to be authenticated to each other, and to use information in certificates (e.g., public keys) and private keys, session keys, Traffic Encryption Keys (TEKs), cryptographic-system-specific keys, and/or other keys, to encrypt and decrypt messages communicated between entities.

In one aspect, the authentication component 202 can compare received authentication information from a user or entity (e.g., password, key, etc.) with authentication information that can be stored in the authentication component 202 and/or a highly secure memory array within the memory module 102. The authentication component 202 can then allow access to a region(s) of the secure memory component 106 if the authentication information (e.g., the authentication information that resides within the authentication component 202 or in a secure memory array, etc.) matches or deny access to the secure memory component 106 if the authentication information does not match.

Conventionally, a memory controller (e.g., a unit that can be located outside of the memory module 102 and can be associated with a processor) can control access to a memory, or a portion thereof. Further, a memory controller typically provides security to only one, if any, region located in a memory. For example, a memory controller typically does not provide security for multiple memory regions wherein different users or entities can “own” certain regions of a memory array (e.g., where each user or entity can gain access to certain regions of the memory array, to the exclusion of all others). Also, the protection provided by a separate memory controller (e.g., via authentication processes) can potentially be bypassed by disconnecting and/or removing the memory from the memory controller. Once a memory controller (with the authentication programs) is removed from the memory, an unauthorized entity can potentially gain access to memory arrays (e.g., memory locations that can be intended to be secure) that can be associated with the memory.

The subject innovation can provide improved security of data associated with the memory module 102 by incorporating the authentication component 202 within the memory module 102 (e.g., on the same silicon die) to facilitate controlling access to the secure memory component 106 associated with the memory array 104. As a result, the risk of unauthorized access of the secure memory component 106 by removing the memory module 102 from an associated memory controller (e.g., a memory controller that manages the security of the memory module) to gain access to the raw data contained in the memory array 104 can be substantially reduced or eliminated.

It is to be appreciated that the disclosed subject matter also contemplates that the improved security with respect to data and the memory component 102 described herein (e.g., providing secure memory component(s) 106 for multiple user(s) and/or entity(ies)) can be facilitated, in accordance with one embodiment, wherein the associated memory controller is contained on the same die as the memory component 102, or, in another embodiment, wherein the associated memory controller is not contained on the same die as the memory component 102, for example.

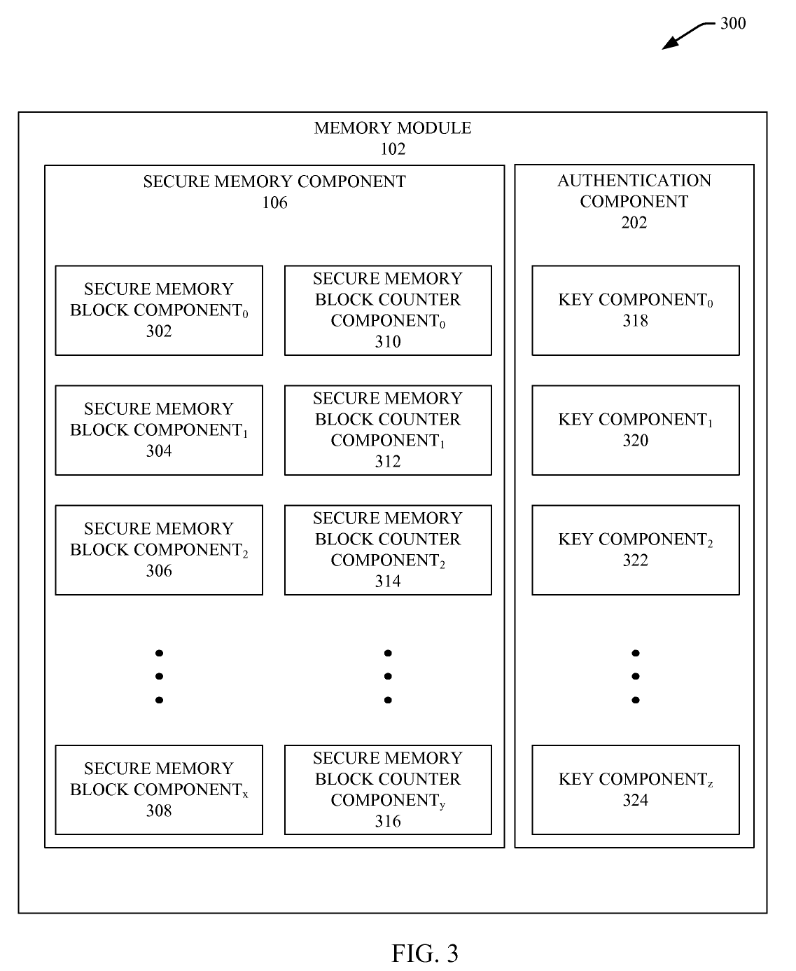

Turning to FIG. 3, depicted is a diagram of a memory device 300 that can facilitate storage of data in accordance with an aspect of the disclosed subject matter. Memory device 300 can include a memory module 102 that can comprise, in part, a secure memory component 106 that can be a part of a memory array (e.g., memory array 104 of FIG. 1). The memory array can comprise non-volatile memory and/or volatile memory. For example, the nonvolatile memory can include, but is not limited to, read-only memory (ROM), flash memory (e.g., single-bit flash memory, multi-bit flash memory), mask-programmed ROM, programmable ROM (PROM), Erasable PROM (EPROM), Ultra Violet (UV)-erase EPROM, one-time programmable ROM, electrically erasable PROM (EEPROM), and/or nonvolatile RAM (e.g., ferroelectric RAM (FeRAM)). The volatile memory can include, but is not limited to, random access memory (RAM), static RAM (SRAM), pseudo-static random access memory (pSRAM), dynamic RAM (DRAM), synchronous DRAM (SDRAM), single data rate SDRAM (SDR SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and/or Rambus dynamic RAM (RDRAM).

The secure memory component 106 can include a plurality of memory block components, such as secure memory block component₀ 302, secure memory block component₁ 304, secure memory block component₂ 306, and secure memory block componentₓ 308 (hereinafter also collectively referred to as “secure memory block components 302 through 308”), where x can be virtually any positive integer number. Each secure memory block components 302 through 308 can be comprised of one or more of memory cells (not shown), wherein data can be stored.

In accordance with one aspect of the disclosed subject matter, each of the secure memory block components 302 through 308 can store data that can be protected from unauthorized access (e.g., via requiring valid authentication information being provided to the authentication component 202 as described in FIG. 2). Each of the secure memory block components 302 through 308 can be associated with a different user(s) and/or entity(ies) wherein only the user(s) and/or entity(ies) that provides the proper authentication information associated with a particular secure memory block component (e.g., one of the secure memory block components 302 through 308) can gain access to that particular secure memory block component. In one aspect, each of the secure memory block components 302 through 308 can be the same size. In another aspect, the secure memory block components 302 through 308 can be different sizes.

In accordance with one embodiment, each of the secure memory block components 302 through 308 can be dedicated to respective users or entities (e.g., OEM, service provider, software provider), where each of the secure memory block components 302 through 308 can be associated with respective authentication information (e.g., password, key, pass phrase), and there can be one or more other secure memory block components 302 through 308 that can be accessed with the authentication information associated with one or more of the secure memory block components 302 through 308. For example, a first user can possess (e.g., to the exclusion of all others) the proper authentication information to access the information contained in the secure memory block component₀ 302. An OEM, for example, can possess the proper authentication information to access the information contained in the secure memory block component₁ 304. Further, a service provider, for example, can possess the proper authentication information to access the information contained in the secure memory block component₂ 306. In addition to using their respective authentication information to access their respective secure memory block components (e.g., 302 through 308), one or more of the secure memory block components (e.g., 308) can be shared between one or more users and/or entities that can access the shared secure memory block component(s) (e.g., 308) by using common authentication information, wherein the authentication component 202 can control the access to the shared secure memory block component(s) (e.g., 308).

The system 300 can also include secure memory block counter component₀ 310, secure memory block counter component₁ 312, secure memory block counter component₂ 314, and secure memory block counter component_{y} 316 (hereinafter collectively also referred to as “secure memory block counter components 310 through 316”), where y can be the same number, for example, as x with respect the secure memory block components 302 through 308. The secure memory block counter components 310 through 316 can correspond with respective secure memory block components 302 through 308. For example, secure memory block counter component₀ 310 can be associated with secure memory block component₀ 302, secure memory block counter component₁ 312 can be associated with secure memory block component₁ 304, etc.

In accordance with one aspect of the disclosed subject matter, the secure memory block counter components 310 through 316 can count the number of times the authentication information for a particular secure memory block components 302 through 308 has been updated. For example, secure memory block counter component₀ 310 can be initialized to a value of “0”. If the authentication information for secure memory block component₀ 302 is updated (e.g., a key that can be associated with the authentication component 202 is changed), then the value for the secure memory block counter component₀ 310 (e.g., which can correspond to the secure memory block component 302) can be incremented to show a value of “1”. In one aspect, this process can continue (e.g., incrementing the secure memory block counter components 310 through 316 when the corresponding authentication information is changed or updated) for each of the secure memory block components 302 through 308. It is to be appreciated that the counter components 310 through 316 can roll over to “0” wherein the “0” value can represent a count of the maximum value the counter components 310 through 316 can count+“1” (e.g. 1111 rolling over to 0000 can be interpreted as 10000. In one embodiment, the authentication information can be stored, for example, in a key component (e.g., key components 318) that can be associated with the authentication component 202, as described herein with respect to system 300, or in another embodiment, the authentication information can be stored in a secure memory array outside the authentication component 202, for example.

System 300 can also include key component₀ 318, key component₁ 320, key component₂ 322, and key component_{z} 324 (hereinafter also collectively referred to as “key components 318 through 324”), wherein the z can be any positive integer and can be the same value as x (in reference to secure memory block components 302 through 308) and y (in reference to secure memory block counter components 310 through 316), for example. As with the secure memory block components 302 through 308 and secure memory block counter components 310 through 316, the key components 318 through 324 can correspond with respective components located within the secure memory component (e.g., the secure memory block components 302 through 308 and secure memory block counter components 310 through 316). For example, key component₀ 318 can be associated with the secure memory block counter components 310 and the secure memory block component₀ 302, wherein the secure memory block counter component₀ 310 can indicate how many times the key component₀ 318 has been updated.

In accordance with one aspect of the disclosed subject matter, the key components 318 through 324 can include two or more storage locations wherein authentication information (e.g., key, passphrase) can be used to authenticate a particular user or entity for access to one or more respective secure memory block components 302 through 308. The key components 318 through 324 can, for example, contain keys of a predetermined size (e.g., 64 bits, 128 bits, 256 bits, etc.). For example, key component₀ 318 can contain four storage locations wherein authentication can be stored for the secure memory block component₀ 302. In such an example, the secure memory block counter components 310 can contain two bits to facilitate counting four potential storage locations (e.g., “0” through “3”). The initial value in the secure memory block counter component₀ 310 can be “0”, for example, to represent the “0” location within the key components 318 that can contain valid authentication information to access the information contained in the secure memory block component₀ 302. In one aspect, a user can update the authentication information contained in the key component₀ 318. When the user updates the authentication information in the key component₀ 318, the authentication component 202 can store the updated authentication information in the “1” place (e.g., the second storage location) of the key component₀ 318 and simultaneously increment the secure memory block counter component₀ 310 to reflect the number of updates to “1”. The authentication component 202 can facilitate comparing the authentication information stored in the second storage location within the key component₀ 318 (e.g., the updated authentication information) to the authentication information presented by the user to gain access to the secure memory block component₀ 302.

It is to be appreciated that each of the key components 318 through 324 can contain from two to virtually any number of storage locations to store authentication information that can be stored in the respective secure memory block components 302 through 308. It is to be further appreciated that the respective secure memory block counter components 310 through 316 can contain a sufficient number of bits to facilitate counting up to the number of authentication information updates (e.g., number of locations that can be contained within the respective key components 318 through 324). For example, if one of the key components 318 through 324 can store up to eight separate authentication keys, the corresponding secure memory block counter components 310 through 316 can contain at least three bits to accommodate counting up to eight (e.g., 0 through 7). Once the highest number of authentication information updates is achieved (e.g., the eighth storage location of one of the key components 318 through 324 that has eight storage locations), the authentication component 202 can facilitate storing the updated authentication information from the beginning of the respective key component 318 through 324 (e.g., in the “0” location of the respective key components 318 through 324), for example. Likewise, the corresponding secure memory block counter components 310 through 316, for example, can “roll over” with the count starting at “0” once the highest number the secure memory block counter components 310 through 316 can increment to is achieved and the authentication information for the respective key components 318 through 324 is updated again.

In accordance with an aspect of the disclosed subject matter, the authentication component 202 can facilitate initially setting in the first storage locations associated with each of the respective key components 318 through 324 to a default value. For example, the authentication component 202 can set the first locations of the key components 318 through 324 to all zeros, and the respective secure memory block counter components 310 through 316 can be set to a default value of “0” (to correspond to the number of times the respective key components 318 through 324 have been updated with new authentication information). The user(s) and/or entities can then access the respective secure memory block components 302 through 308 by using the zeros (e.g., the zeros placed in the first storage locations associated with the respective key components 318 through 324) for authentication.

It is to be appreciated that, in accordance with another embodiment, the disclosed subject matter contemplates that the key components 318 through 324 associated with the respective secure memory block counter components 310 through 316 can also be implemented by utilizing a single key component (e.g., 318) that can have P+R storage locations for storing the authentication information, wherein the P can be equivalent to the number of secure memory block components 302 through 308 that can be associated with an embodiment of the disclosed subject matter. The R storage locations can be one or more additional storage locations that can be used, for example, to store new authentication information when authentication information is being changed or updated for a particular secure memory block component (e.g., 302, 304, 306, 308). In one aspect, the new storage location can be associated with the particular secure memory block component when the update is successfully completed. In another aspect, if the change is successful (e.g., if there is no power loss during the authentication information update), the old storage location within the key component that corresponds to the respective secure memory block component (e.g., 302, 304, 306, 308) and that contained the old authentication information can be erased/reset.

If, for example, there is a power loss during the update, the two storage locations (e.g., the old storage location and the new storage location in the key component and that are related to the respective secure memory block component) would have different authentication information, and the authentication component 202 can facilitate determining which of the two storage locations contains the desired authentication information (e.g., if the new authentication information is corrupted during the update, the authentication component 202 can utilize the old authentication information in the old storage location, and can facilitate notifying the user that the update was not performed successfully; if the new authentication information is determined to not be corrupted, the authentication component 202 can determine that the update is performed successfully, and the authentication component 202 can facilitate an erase or reset of the old storage location so that it is available for the next update). It is to be appreciated that such an embodiment can allow for a smaller number of storage locations for storing respective authentication information associated with one or more secure memory block components 302 through 308, for example.

One of the advantages to having multiple storage locations associated with the one or more key components 318 through 324 (or an additional storage location in a single key component, in accordance with one embodiment) is that a user or entity can update the authentication information within one of the key components 318 through 324 without potentially losing previous authentication information associated with the secure memory block components 302 through 308. The authentication component 202 can facilitate querying the respective secure memory block counter components 310 through 316 to see which storage location within the respective key components 318 through 324 can be compared to the authentication information presented by a user or entity. The use of multiple storage locations to store authentication information associated with one or more of the secure memory block components 302 through 308 can, for example, protect one from potentially losing authentication information that can be associated with one or more of the secure memory block components 302 through 308 (e.g., if the memory module 102 loses power during the updating process of authentication information).

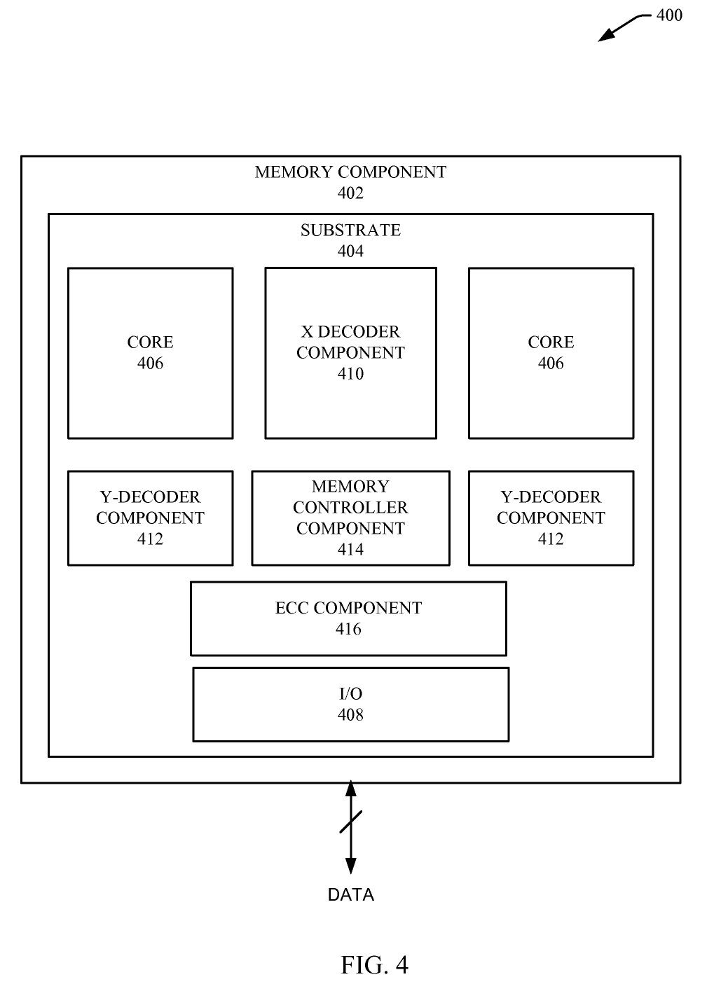

Referring to FIG. 4 illustrated is a block diagram of a system 400 that can facilitate storage of data in accordance with one embodiment the disclosed subject matter. In accordance with an aspect, the system 400 can be or can include a memory component 402, which can be, for example, a flash memory (e.g., single-bit flash memory, multi-bit flash memory) or other type of memory, that can be created on a semiconductor substrate 404 in which one or more core regions 406, which can be higher-density core regions, and one or more peripheral regions, which can be lower-density regions, can be formed. It is to be appreciated that the memory component 402 can be the nonvolatile memory included in memory module 102 (e.g., as described in system 100) and can comprise a secure memory component 106 and a general memory component 108 (e.g., not shown in FIG. 4; as depicted in FIG. 1 and described herein). The high-density core regions 406 can include one or more M by N arrays (e.g., memory array 104) of individually addressable, substantially identical multi-bit memory cells (not shown). The memory cells in memory component 402 can retain stored data even while disconnected from a power source.

The lower-density peripheral regions can typically include an input/output component 408 (e.g., input/output (I/O) circuitry) and programming circuitry for selectively addressing the individual memory cells. The programming circuitry can be represented in part by and can include one or more x-decoder components 410 and one or more y-decoder components 412 that can cooperate with the I/O component 408 for selectively connecting a source (not shown), gate (not shown), and/or drain (not shown) of selected addressed memory cells to predetermined voltages or impedances to effect designated operations (e.g., programming, reading, verifying, erasing) on the respective memory cells, and deriving necessary voltages to effect such operations. For example, an x-decoder component 410 and a y-decoder component 412 can each receive address bus information, which can be provided as part of a command, and such information can be utilized to facilitate determining the desired memory cell(s) in the memory component 402.

System 400 can also include a memory controller component 414 that can facilitate control of the flow of data to and from the memory component 402. In one aspect, the memory controller component 414, by itself or in conjunction with a host processor (not shown), can facilitate execution of operations (e.g., read, write, erase) associated with memory locations in the core(s) 406. In another aspect, the memory controller component 414 can facilitate verifying and/or maintaining the desired charge level(s) associated with data stored in the memory locations in the core(s) 406. In accordance with one embodiment of the disclosed subject matter, the memory module 102 can be, in part, or can include the memory component 402.

It is to be appreciated that the system 400 refers to one embodiment of a memory 402, and the subject innovation is not so limited, as the subject innovation can comprise a memory that can include nonvolatile memory and/or volatile memory. The storage components of such a memory can include, for example, other components (e.g., resistive components (not shown), diode components (not shown)), magnetic spin-type components (not shown) that are not explicitly described herein, where such components can facilitate, for example, the storage and/or control of data.

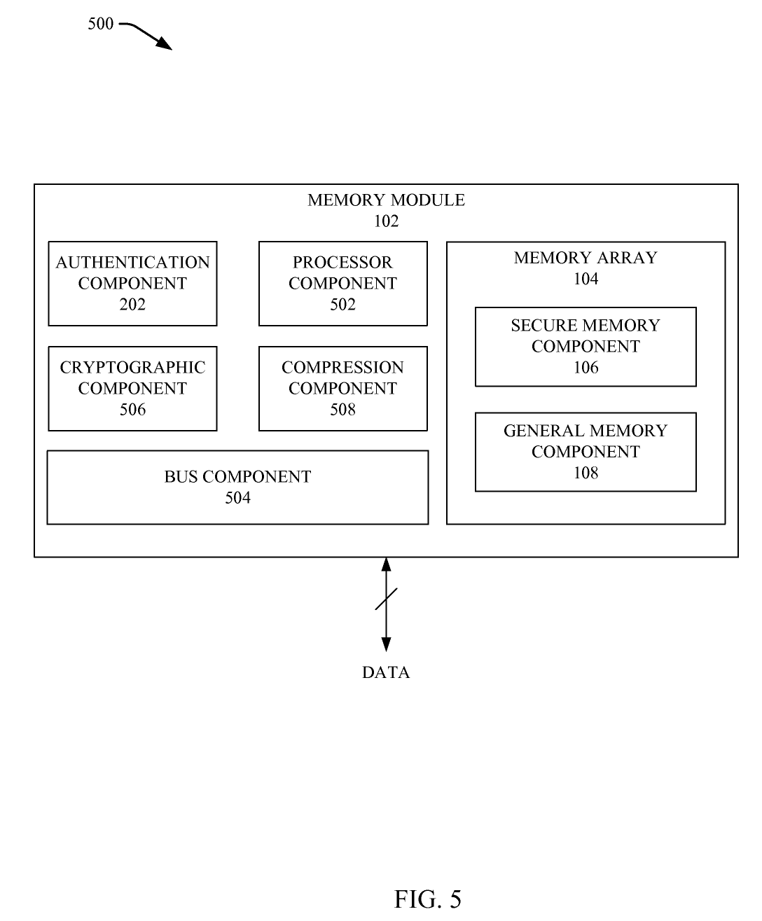

Referring to FIG. 5, illustrated is a block diagram of a system 500 that can employ secure memory component associated with a memory module in accordance with an aspect of the disclosed subject matter. System 500 can include a memory module 102 that can facilitate storage of data. The memory component 102 can include a memory array(s) 104 (e.g., nonvolatile memory array) that can comprise a secure memory component 106 for storing data to be accessed by an authorized user and a general memory component 108 that can be accessed by anyone in possession of the memory module 102, for example. The memory component 102 can also include an authentication component 202 that can facilitate controlling access to one or more secure memory block components 302 through 308 (e.g., as depicted in FIG. 3) that can be associated with the secure memory component 106. For example, once a user or entity is properly authenticated, the authentication component 202 can grant access to the corresponding secure memory block component (e.g., 302) by enabling read, write, and/or erase operations to be performed on the secure memory block component. The memory array 104 can be, in part, comprised of ROM, flash memory (e.g., single-bit flash memory, multi-bit flash memory), mask-programmed ROM, PROM, EPROM, UV-erase EPROM, one-time programmable ROM, and/or EEPROM, for example. It is to be appreciated and understood that the memory module 102, the memory array(s) 104, secure memory component 106, general memory component 108 each can be the same or similar, and/or can contain the same or similar functionality, as respective components, as more fully described herein, for example, with regard to system 100, system 200, system 300, and/or system 400.

In one aspect, the authentication component 202 can solicit authentication information from a user or entity, and, upon the authentication information so solicited, can be employed, individually and/or in conjunction with information acquired and ascertained as a result of biometric modalities employed, to facilitate controlling access to one or more of the secure memory block components (e.g., 302 through 308 of FIG. 3) that can be associate with the secure memory component 106. The authentication data can be in the form of a password (e.g., a sequence of humanly cognizable characters), a pass phrase (e.g., a sequence of alphanumeric characters that can be similar to a typical password but is conventionally of greater length and contains non-humanly cognizable characters in addition to humanly cognizable characters), a pass code (e.g., Personal Identification Number (PIN)), a physical signature (e.g., PUF), and the like, that can be stored in a key component (e.g., key components 318 through 324 of FIG. 3 (not shown in FIG. 5)), for example. Additionally and/or alternatively, public key infrastructure (PKI) data can also be employed by authentication component 202. PKI arrangements can provide for trusted third parties to vet, and affirm, entity identity through the use of public keys that typically can be certificates issued by the trusted third parties. Such arrangements can enable entities to be authenticated to each other, and to use information in certificates (e.g., public keys) and private keys, session keys, Traffic Encryption Keys (TEKs), cryptographic-system-specific keys, and/or other keys, to encrypt and decrypt messages communicated between entities.

In accordance with one embodiment of the disclosed subject matter, the memory module 102 can include a processor component 502 that can be associated with the memory array 104, for example. The processor component 502 can be a typical applications processor that can manage communications and run applications. For example, the processor component 502 can be a processor that can be utilized by a computer, a mobile handset, PDA, or other electronic device. The processor component 502 can generate commands, including read, write, and/or erase commands, in order to facilitate reading data from, writing data to, and/or erasing data from the memory array 104 (e.g., the secure memory component 106 and/or the general memory component 108), where the communication of information between the processor component 502 and the memory array 104 can be facilitated via a bus component 504. In accordance with another embodiment, the processor component 502 can be a stand-alone unit that can be associated with the memory module 102, and can generate and execute commands to access data to/from the memory array 104.

The bus component 504 can provide a network or electrical interconnect between electric and/or semiconductor components within the memory module 102 including, but not limited to, the processor component 502, the authentication component 202, a cryptographic component 506, a compression component 508, and/or the memory array 104. The bus component 504 can be comprised of any of several types of bus structure(s) including the memory bus or memory controller, a peripheral bus or external bus, and/or a local bus using any variety of available bus architectures including, but not limited to, Advanced Microcontroller Bus Architecture (AMBA), Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

In accordance with yet another aspect of the disclosed subject matter, the processor component 502, the authentication component 202, or a combination thereof, can facilitate the encryption and/or decryption of data that can be associated with one or more of the secure memory block components (e.g., secure memory block components 302 through 308 of FIG. 3) by transferring data and key/authentication information to the cryptographic component 506 prior to storing the data into the secure memory component 106 and/or prior to providing the data retrieved from the secure memory component 106, for example. The cryptographic component 506 can include a security engine (not shown) that can be configured to perform cryptographic functions that can facilitate securing data written to, stored in, and/or read from the secure memory block components, for example. Cryptographic functions, such as, for instance, encryption, decryption, key generation, and/or hash, to facilitate data security can be employed in conjunction with the processor component 502 and can include use of symmetric and/or asymmetric algorithms, such as Advanced Encryption Standard (AES)—a block symmetric key cipher, Data Encryption Standard (DES), Triple Data Encryption Standard (3DES)—a block cipher form by utilizing the DES cipher at least three times, Secure Hash Algorithm (SHA) and its variants such as, for example, SHA-0, SHA-1, SHA-224, SHA-256, SHA-384, and SHA-512, and the Rivest, Shamir, and Adleman (RSA) encryption algorithm, and the like.

In accordance with yet another aspect of the disclosed subject matter, the processor component 502 can facilitate compression of data that can be stored in the memory array 104 by directing data to be stored to one or more of the memory locations (e.g., secure memory block components 302 through 308 of FIG. 3) to the compression component 508 prior to storing the data into the memory array 104. The compression component 508 can provide compression of data by encoding information using fewer bits than an unencoded representation of data would use through use of encoding schemes that can employ data compression algorithms, such as lossless compression algorithms or lossy compression algorithms, for example. The compression component 508 can be used in conjunction with any combination of other electric and/or semiconductor components (e.g., cryptographic component 506, authentication component 202, processor component 502) to perform a combination of operations on the data associated with the secure memory component 106 and/or general memory component 108 that can be associated with the memory array 104.

In accordance with one embodiment of the disclosed subject matter, the system 400 can also include an error-correction code (ECC) component 416 that can facilitate the detection and correction of data associated with the memory component 402. For example, the ECC component 416 can detect and correct errors that can be associated with data that can be read and written to/from the memory component 402 (e.g., to the core(s) 406).

The aforementioned systems and/or devices have been described with respect to interaction between several components. It should be appreciated that such systems and components can include those components or sub-components specified therein, some of the specified components or sub-components, and/or additional components. It is to be appreciated that one or more components and/or sub-components contained within a system can be combined into a single component providing aggregate functionality, for example. The components may also interact with one or more other components not specifically described herein for the sake of brevity, but known by those of skill in the art.

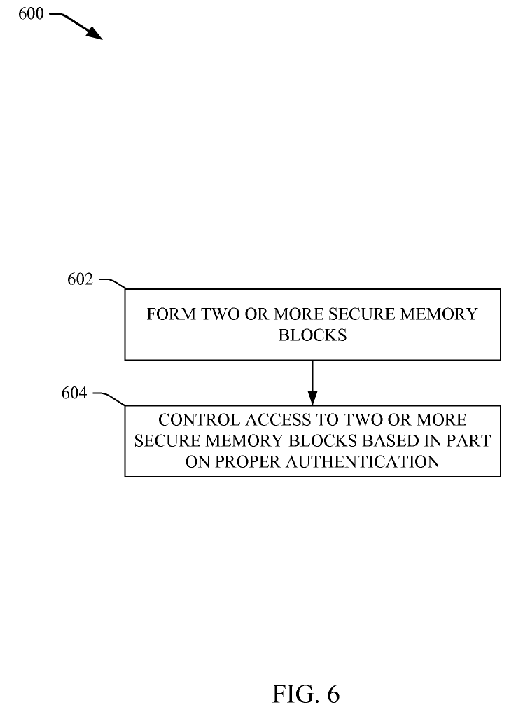

FIGS. 6-8 illustrate methodologies and/or flow diagrams in accordance with the disclosed subject matter. For simplicity of explanation, the methodologies are depicted and described as a series of acts. It is to be understood and appreciated that the subject innovation is not limited by the acts illustrated and/or by the order of acts, for example acts can occur in various orders and/or concurrently, and with other acts not presented and described herein. Furthermore, not all illustrated acts may be required to implement the methodologies in accordance with the disclosed subject matter. In addition, those skilled in the art will understand and appreciate that the methodologies could alternatively be represented as a series of interrelated states via a state diagram or events. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

Referring to FIG. 6, a methodology 600 that can facilitate controlling access to data associated with a memory in accordance with an aspect of the disclosed subject matter is illustrated. At 602, two or more secure memory blocks can be formed. For example, two or more secure memory block components (e.g., secure memory block components 302 through 308 of FIG. 3) can be formed in a memory module (e.g., memory module 102 as illustrated in FIG. 1, FIG. 2, FIG. 3, etc. and described herein). In one aspect, the memory module can comprise a plurality of memory cells that can be contained in a memory array(s) (e.g., memory array 104 of FIG. 1 and FIG. 2). The two or more secure memory block components can contain data/information that can be secure from unauthorized access, for example.

At 604, access to the two or more secure memory block components can be enabled based in part on proper authentication. In one aspect, each of the two or more secure memory block components can be associated with respective authentication information (e.g., key, pass phrase) that can be stored in a corresponding key component (e.g., key components 318 through 324 of FIG. 3) or other secure storage location. An authentication component (e.g., authentication component 202 of FIG. 2, FIG. 3, and/or FIG. 5) can, for example, receive authentication information from a user or entity (e.g., OEM, service provider) and compare the received authentication information with the authentication information contained in a respective key component (e.g., key components 318 through 324 of FIG. 3) that corresponds to the respective secure memory block component (e.g., secure memory block components 302 through 308 of FIG. 3). If the authentication information matches (e.g., the received authentication information and the authentication information stored in the respective key component), then the authentication component can grant the user or entity access to perform such functions as reads, writes, and erases, for example, on the secure memory block component that corresponds with the authentication information.

It is to be appreciated that the subject innovation facilitates securing data by controlling access to secure memory block components in the memory module. Further, the subject innovation can facilitate data security facilitates providing data security to more than one distinct area (e.g., secure memory block components 302 through 308 of FIG. 3) within a memory module (e.g., memory module 102 of FIG. 1). At this point, methodology 600 can end.

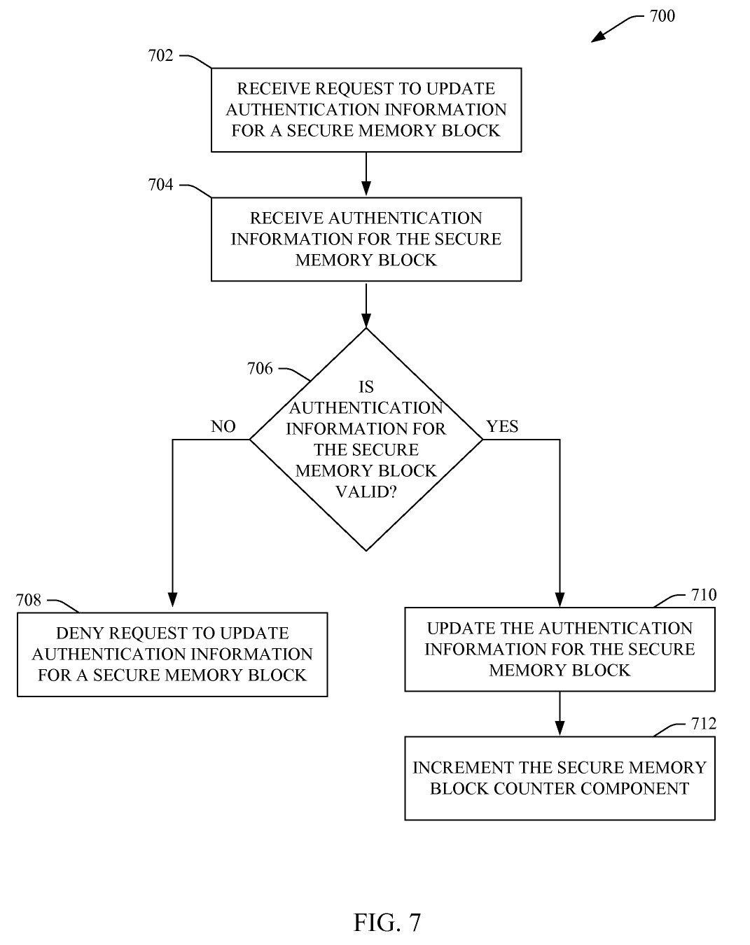

Turning to FIG. 7, depicted is a methodology 700 that can facilitate updating authentication information in accordance with an aspect of the disclosed subject matter. At 702, a request to update authentication information that can be associated with a secure memory block can be received. In accordance with one aspect of the disclosed subject matter, a user or entity can desire to change the authentication information, such as change the authentication information from a default value or from a value that the user had previously set, for example. For example, an authentication component (e.g., authentication component 202 of FIG. 3 and/or FIG. 5) can receive a request, for example, via a processor component (e.g., processor component 502 of FIG. 5) to change or update the authentication information that can be contained in a key component (e.g., one of the key components 318 through 324 of FIG. 3) that can be associated with a secure memory block component (e.g., a respective secure memory block component 302 through 308 of FIG. 3).

At 704, authentication information can be received. In accordance with one aspect of the disclosed subject matter, the user or entity can input the authentication information into the memory module (e.g., memory module 102 of FIG. 1), which can be facilitated, for example by the processor component. The authentication information can be passed to an authentication component (authentication component 202 of FIG. 2) wherein the authentication component can begin the process of comparing the received authentication information with the authentication information that is stored in the authentication component (e.g., within one of the corresponding key components 318 through 324 of FIG. 3).

At 706, a determination can be made as to whether the received authentication information is valid. For example, the authentication component can compare the received authentication information with the authentication information that is stored in a key component (e.g., one of the key components 318 through 324 of FIG. 3) that can be associated with a secure memory block (e.g., one of the corresponding secure memory block components 302 through 308 of FIG. 3).

In one aspect, the authentication component can facilitate comparing the received authentication information to one of the locations contained within the key component that can be depicted by a corresponding secure memory block counter component (e.g., secure memory block counter components 310 through 316 of FIG. 3). For example, if the corresponding secure memory block counter components 310 through 316 is set to “2”, the authentication component can compare the received authentication information to the third storage location that can be associated with the key component, wherein, for instance, the secure memory block counter component can initially be set to zero (e.g., thus resulting in comparing the received authentication information to the third location associated with the key component).

If, at reference numeral 706, it is determined that the received authentication information is not valid, at 708, the request to update the authentication information for a secure memory block can be denied and/or ignored. For example, if a user or entity provides incorrect authentication information to change the authentication information contained in one of the key components associated with the authentication component, the authentication component can deny the request and thus leave the data (e.g., the authentication information) that is stored in the key component unchanged.

If, at reference numeral 706, it is determined that the received authentication information is valid, such as where the received authentication information matches the authentication information associated with the secure memory block component for which access is desired, at 710, the authentication information associated with that secure memory block component can be updated. For instance, when access to the secure memory block component based in part on valid authentication information being presented, different authentication information (e.g., updated authentication information) can be presented as part of the request to update the authentication information, and the authentication component can receive the updated authentication information, which can be stored in a secure area in the memory array (e.g., key component).

At 712, the count associated with the secure memory block counter component can be incremented. In one aspect, the authentication component (e.g., authentication component 202 of FIG. 2) and/or a processor component can facilitate incrementing the count associated with the respective secure memory block counter component (e.g., one of the respective secure memory block counter components 310 through 316 of FIG. 3). In accordance with one aspect of the disclosed subject matter, the incrementing of the count associated with the secure memory block counter component can facilitate accessing the current storage location associated with the respective key component (e.g., the current authentication information) for controlling access to the respective secure memory block component. At this point, methodology 700 can end.

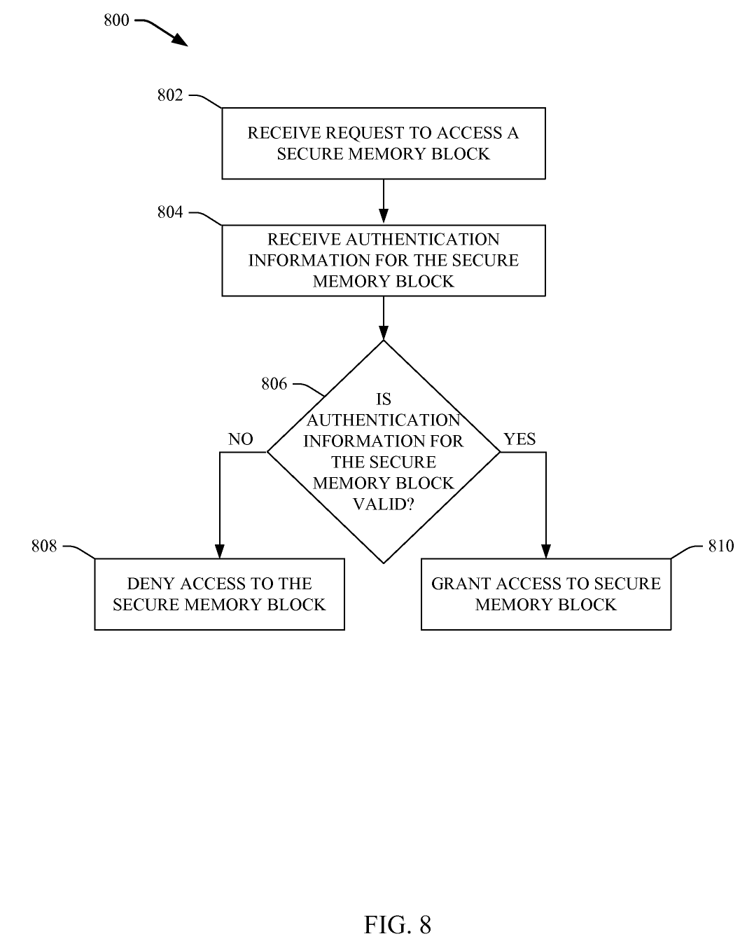

FIG. 8 depicts a methodology 800 that can facilitate controlling access to a secure memory block in accordance with an aspect of the disclosed subject matter. At 802, a request to the secure memory block can be received. In one aspect, a user can request access to the secure memory block components (e.g., secure memory block components 302 through 308 of FIG. 3). The request can be handled by an authentication component (e.g. authentication component 202 of FIG. 2), a processor (e.g., processor component 502 of FIG. 5), or a combination thereof, for example. The authentication component, processor component, or a combination thereof, can accept the request to gain access to the secure memory block component; however, the authentication component, processor component, or a combination thereof, can facilitate waiting until proper authentication information is received from a user or entity before access can be granted.

At 804, authentication information for the secure memory block(s) can be received. In one aspect, the authentication component can receive the authentication information, which can be input by a user via an interface associated with the memory module (e.g., memory module 102 of FIG. 1). The authentication information can be in the form of a password (e.g., a sequence of humanly cognizable characters), a pass phrase (e.g., a sequence of alphanumeric characters that can be similar to a typical password but is conventionally of greater length and contains non-humanly cognizable characters in addition to humanly cognizable characters), a pass code (e.g., Personal Identification Number (PIN)), and the like, for example.

At 806, a determination can be made regarding whether the received authentication information is valid. In one aspect, the authentication component can compare the received authentication information to authentication information that can be stored in one of the storage locations that can be associated with the respective key components (e.g., key components 318 through 324 of FIG. 3). In one aspect, the authentication component, the processor component, or a combination thereof, can query the corresponding secure memory block counter component (e.g., one of the secure memory block counter components 310 through 316 of FIG. 3 that corresponds with the respective key components 318 through 324 of FIG. 3) and, based in part on the count information, can determine which storage location within the respective key component has the current authentication information. The authentication component and/or processor component can retrieve the current authentication information associated with the secure memory block from the appropriate secure storage location of the key component. The authentication component, the processor component, or a combination thereof, can compare the authentication information received from the user and the authentication information retrieved from the storage location within the key component. If the authentication information that is received from the user does not match the current authentication information associated with the secure memory block, the authentication information can be considered not valid. If, for example, the received authentication information does match the current authentication information associated with the secure memory block, the authentication information can be considered valid.

If, at 806, the authentication information is determined not to be valid, at 808, the access to the secure memory block can be denied. For example, if the authentication component receives invalid authentication information associated with respect to the secure memory block component, the authentication component can block or deny access to that secure memory block component.

Returning back to reference numeral 806, if it is determined that the authentication information that is received is valid, at 810, access to the secure memory block(s) can be granted. For example, if the user that initiated the request to gain access to the secure memory block provides authentication information that matches the corresponding current authentication information, which can be contained in the current storage location of the key component associated with the secure memory block component with which the user desires to gain access, the authentication component can grant access to the user and can allow the user to write information to, read information from, and/or erase information contained in, the secure memory block component. At this point, methodology 800 can end.

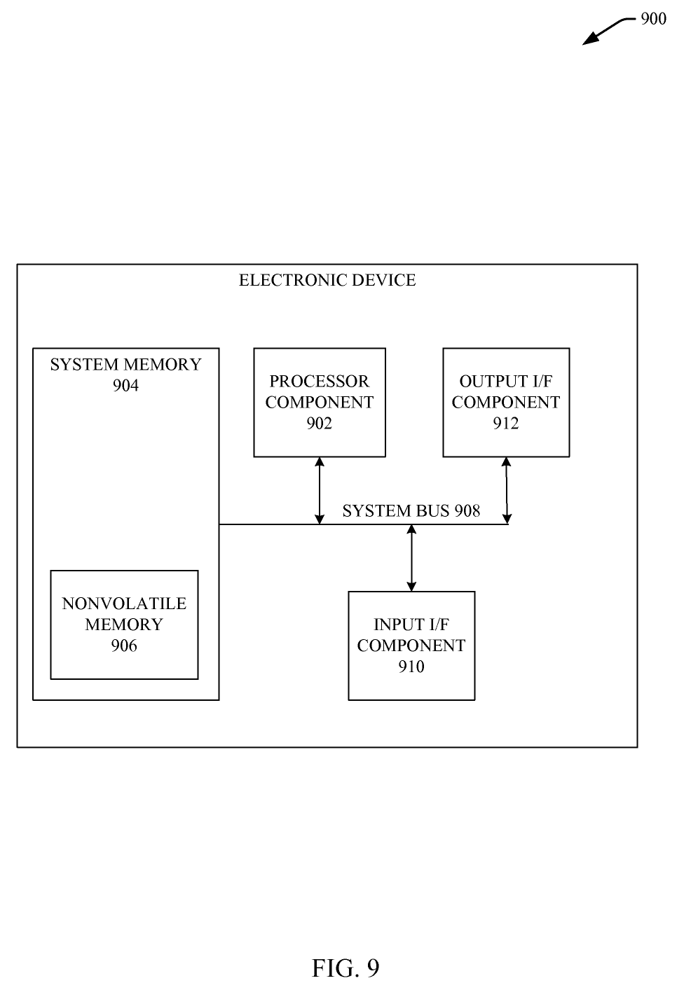

Referring to FIG. 9, illustrated is a block diagram of an exemplary, non-limiting electronic device 900 that can comprise and/or incorporate system 100, system 200, memory device 300, system 400, and/or system 500, or a respective portion(s) thereof. The electronic device 900 can include, but is not limited to, a computer, a laptop computer, network equipment (e.g., routers, access points), a media player and/or recorder (e.g., audio player and/or recorder, video player and/or recorder), a television, a smart card, a phone, a cellular phone, a smart phone, an electronic organizer, a PDA, a portable email reader, a digital camera, an electronic game (e.g., video game), an electronic device associated with digital rights management, a Personal Computer Memory Card International Association (PCMCIA) card, a trusted platform module (TPM), a Hardware Security Module (HSM), set-top boxes, a digital video recorder, a gaming console, a navigation system or device (e.g., global position satellite (GPS) system), a secure memory device with computational capabilities, a device with a tamper-resistant chip(s), an electronic device associated with an industrial control system, an embedded computer in a machine (e.g., an airplane, a copier, a motor vehicle, a microwave oven), and the like.

Components of the electronic device 900 can include, but are not limited to, a processor component 902 (e.g., which can be and/or can include the same or similar functionality as processor component 502, as depicted in FIG. 5 and described herein), a system memory 904, which can contain a nonvolatile memory 906, and a system bus 908 that can couple various system components including the system memory 904 to the processor component 902. The system bus 908 can be any of several types of bus structures including a memory bus or memory controller, a peripheral bus, or a local bus using any of a variety of bus architectures.

Electronic device 900 can typically include a variety of computer readable media. Computer readable media can be any available media that can be accessed by the electronic device 900. By way of example, and not limitation, computer readable media can comprise computer storage media and communication media. Computer storage media includes volatile and non-volatile, removable and non-removable media implemented in any method or technology for storage of information such as computer readable instructions, data structures, program modules or other data. Computer storage media includes, but is not limited to, RAM, ROM, EEPROM, nonvolatile memory 906 (e.g., flash memory), or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by electronic device 900. Communication media typically embodies computer readable instructions, data structures, program modules or other data in a modulated data signal such as a carrier wave or other transport mechanism and includes any information delivery media.

The system memory 904 can include computer storage media in the form of volatile (e.g., SRAM) and/or nonvolatile memory 906 (e.g., flash memory). For example, nonvolatile memory 906 can be the same or similar, or can contain the same or similar functionality, as memory module 102 (e.g., as described herein with regard to system 100, system 200, system 400, etc.). A basic input/output system (BIOS), containing the basic routines that can facilitate transferring information between elements within electronic device 900, such as during start-up, can be stored in the system memory 904. The system memory 904 typically also can contain data and/or program modules that can be accessible to and/or presently be operated on by the processor component 902. By way of example, and not limitation, the system memory 904 can also include an operating system(s), application programs, other program modules, and program data.

The nonvolatile memory 906 can be removable or non-removable. For example, the nonvolatile memory 906 can be in the form of a removable memory card or a USB flash drive. In accordance with one aspect, the nonvolatile memory 906 can include flash memory (e.g., single-bit flash memory, multi-bit flash memory), ROM, PROM, EPROM, EEPROM, or NVRAM (e.g., FeRAM), or a combination thereof, for example. Further, a flash memory can comprise NOR flash memory and/or NAND flash memory.

A user can enter commands and information into the electronic device 900 through input devices (not shown) such as a keypad, microphone, tablet, or touch screen although other input devices can also be utilized. These and other input devices can be connected to the processor component 902 through input interface component 910 that can be connected to the system bus 908. Other interface and bus structures, such as a parallel port, game port or a universal serial bus (USB) can also be utilized. A graphics subsystem (not shown) can also be connected to the system bus 908. A display device (not shown) can be also connected to the system bus 908 via an interface, such as output interface component 912, which can in turn communicate with video memory. In addition to a display, the electronic device 900 can also include other peripheral output devices such as speakers (not shown), which can be connected through output interface component 912.

It is to be understood and appreciated that the computer-implemented programs and software can be implemented within a standard computer architecture. While some aspects of the disclosure have been described above in the general context of computer-executable instructions that can be run on one or more computers, those skilled in the art will recognize that the technology also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices (e.g., PDA, phone), microprocessor-based or programmable consumer electronics, and the like, each of which can be operatively coupled to one or more associated devices.

The illustrated aspects of the disclosure may also be practiced in distributed computing environments where certain tasks are performed by remote processing devices that are linked through a communications network. In a distributed computing environment, program modules can be located in both local and remote memory storage devices.

As utilized herein, terms “component,” “system,” “interface,” and the like, can refer to a computer-related entity, either hardware, software (e.g., in execution), and/or firmware. For example, a component can be a process running on a processor, a processor, an object, an executable, a program, and/or a computer. By way of illustration, both an application running on a server and the server can be a component. One or more components can reside within a process and a component can be localized on one computer and/or distributed between two or more computers.

Furthermore, the disclosed subject matter can be implemented as a method, apparatus, or article of manufacture using standard programming and/or engineering techniques to produce software, firmware, hardware, or any combination thereof, to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the disclosed subject matter.

Some portions of the detailed description have been presented in terms of algorithms and/or symbolic representations of operations on data bits within a computer memory. These algorithmic descriptions and/or representations are the means employed by those cognizant in the art to most effectively convey the substance of their work to others equally skilled. An algorithm is here, generally, conceived to be a self-consistent sequence of acts leading to a desired result. The acts are those requiring physical manipulations of physical quantities. Typically, though not necessarily, these quantities take the form of electrical and/or magnetic signals capable of being stored, transferred, combined, compared, and/or otherwise manipulated.

It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the foregoing discussion, it is appreciated that throughout the disclosed subject matter, discussions utilizing terms such as processing, computing, calculating, determining, and/or displaying, and the like, refer to the action and processes of computer systems, and/or similar consumer and/or industrial electronic devices and/or machines, that manipulate and/or transform data represented as physical (electrical and/or electronic) quantities within the computer's and/or machine's registers and memories into other data similarly represented as physical quantities within the machine and/or computer system memories or registers or other such information storage, transmission and/or display devices.

What has been described above includes examples of aspects of the disclosed subject matter. It is, of course, not possible to describe every conceivable combination of components or methodologies for purposes of describing the disclosed subject matter, but one of ordinary skill in the art may recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “has,” or “having,” or variations thereof, are used in either the detailed description or the claims, such terms are intended to be inclusive in a manner similar to the term “comprising” as “comprising” is interpreted when employed as a transitional word in a claim.

What is claimed is:

1. A system that facilitates control of access to data, comprising:
a memory module that contains a plurality of secure memory block components, wherein the plurality of secure memory block components facilitate storage of data; and
an authentication component that contains a plurality of key components that respectively contain authentication information that respectively correspond with the plurality of secure memory block components, wherein the authentication component facilitates control of access to the plurality of secure memory block components based in part on authentication information respectively associated with each secure memory block component.

2. The system of claim 1, wherein the plurality of key components each contain at least two storage locations to facilitate storage of authentication information in order to facilitate the control of access to the respective plurality of secure memory block components.

3. The system of claim 2, wherein the authentication component facilitates control of access to the plurality of secure memory block components in part by a comparison of received authentication information from a user with stored authentication information contained in one of the at least two storage locations associated with the respective plurality of key components.

4. The system of claim 2, wherein one of the at least two storage locations within one of the plurality of key components is used to store authentication information required to gain access more than one of the plurality of secure memory block components.

5. The system of claim 2, further comprising a plurality of secure memory block counter components, wherein the plurality of secure memory block counter components tracks the count of the number of times the authentication information is updated in the respective plurality of key components to facilitate access of current authentication information.

6. The system of claim 5, wherein the number of secure memory block components contained in the plurality of secure memory block components equals the number secure memory block counter components that are contained in the plurality of secure memory block counter components and the number of key components contained in the plurality of key components.

7. The system of claim 5, wherein the memory module, the authentication component, the plurality of key components, the plurality of secure memory block components, and the plurality of secure memory block counter components are contained on the same silicon die.

8. The system of claim 1, the memory module contains a nonvolatile memory that is at least one of flash memory, mask-programmed read only memory, programmable read only memory, erasable programmable read only memory, ultra-violet-erase erasable programmable read only memory, one-time programmable read only memory, or electrically erasable programmable read only memory, or a combination thereof.

9. The system of claim 1, further comprising a processor component that facilitates control of access to the plurality of secure memory block components.

10. The system of claim 1, wherein the authentication component, the plurality of key components, the plurality of secure memory block components, the plurality of secure memory block counter components, or a combination thereof are formed on a single silicon die.

11. The system of claim 1, further comprising at least one general memory component, wherein the at least one general memory component that is accessible without authentication.

12. The system of claim 1, further comprising a cryptographic component that facilitates at least one of encryption or decryption of the data that is stored in one or more of the plurality of secure memory block components.

13. An electronic device comprising the system of claim 1.

14. The electronic device of claim 13, the electronic device is one of a computer, a cellular phone, a digital phone, a video device, a smart card, a personal digital assistant, a television, an electronic game, a digital camera, an electronic organizer, an audio player, an audio recorder, an electronic device associated with digital rights management, a Personal Computer Memory Card International Association (PCMCIA) card, a trusted platform module (TPM), an electronic control unit associated with a motor vehicle, a global positioning satellite (GPS) device, an electronic device associated with an airplane, an electronic device associated with an industrial control system, a Hardware Security Module (HSM), a set-top box, a secure memory device with computational capabilities, or an electronic device with at least one tamper-resistant chip.

15. A method that facilitates controlling access to a memory module, comprising:
forming a plurality of secure memory block components in the at least one memory module; and
controlling access to the plurality of secure memory block components based in part on authentication information.

16. The method of claim 15, further comprising:
receiving a request to update authentication information for one of the plurality secure memory block components;
receiving authentication information associated with the one of the plurality of secure memory block components;
comparing the received authentication information with authentication information contained in one of a plurality of storage locations associated with one of a plurality of key components; and
at least one of:
denying the request to update the authentication information for the one of the plurality of secure memory block components, or
updating the authentication information to create a current authentication information for the one of the plurality of secure memory block components, and
incrementing a corresponding one of plurality of secure memory block counter components that is associated with the one of the plurality of secure memory block components.

17. The method of claim 16, further comprising storing the current authentication information in one of the plurality of key components that is associated with the one of the plurality of secure memory block counter components.

18. The method of claim 15, further comprising:
receiving a request to gain access to one of the plurality of secure memory block components;
receiving authentication information associated with the one of the plurality of secure memory block components;
determining if the authentication information associated with the one of the plurality of secure memory block components is valid; and
at least one of:
denying access to the one of the plurality of secure memory block components, or
granting access to the one of the plurality of secure memory block components.

19. The method of claim 15, further comprising:
setting the plurality of secure memory block components to default values; and
setting the plurality of storage locations associated with the plurality of key components to default values.

20. The method of claim 15, further comprising:
compressing the data associated with one of the plurality of secure memory block components; and
at least one of:
encrypting the data associated with one of the plurality of secure memory block components, or
decrypting the data associated with one of the plurality of secure memory block components.
